(19) United States
(12) Patent Application Publication
(10) Pub. No.: US 2005/0012021 A1
(43) Pub. Date: Jan. 20, 2005

(54) Profiled photovoltaic roofing panel

(76) Inventors: EriK Middelman, Arnhem (NL); Leonie Arina Stigter, Driebergen (NL)

Correspondence Address: OLIFF & BERRIDGE, PLC, P.O. BOX 19928, ALEXANDRIA, VA, 22320, US

(21) Appl. No.: 10/498,544

(22) PCT Filed: Dec. 18, 2002
(86) PCT No.: PCT/EP02/14517

(30) Foreign Application Priority Data
Dec. 21, 2001 (NL) 1019701

(51) Int. Cl. G01J 1/00; H01J 40/00

(52) U.S. Cl. 250/200

(57) ABSTRACT

The invention pertains to a photovoltaic roofing panel comprising a carrier and a solar cell unit, the solar cell unit being divided into individual solar cells with at least two solar cells being connected in series, wherein at least one solar cell is connected in series to a non-adjacent solar cell. Preferably, each cell in n connection in series will supply essentially the same amount of current. More preferably, the invention pertains to photovoltaic roofing panel comprising a carrier and a solar cell unit, with the carrier having a recurrent profile with a recurrent pattern length l and a length of the profile k, with the length of the profile k being the length of the profile in the recurrent pattern length l, with the carrier being provided with a solar cell unit which perpendicular to the recurrent pattern length l is divided up into solar cells c₁ . . . cₙ having a width w₁ . . . wₙ, with the sum of w₁ . . . wₙ being equal to the length of the profile k, and with at least one cell c₁ . . . cₙ being connected in series with the corresponding cell c₁ . . . cₙ of another recurrent profile. The invention further pertains to a flexible solar cell foil comprising a solar cell unit divided into individual solar cells with at least two solar cells being connected in series, wherein at least one solar cell is connected in series to a non-adjacent solar cell.

The invention pertains to a profiled photovoltaic roofing panel, more particularly, to a profiled photovoltaic roofing panel comprising a carrier and a solar cell unit which comprises solar cells connected in series. The invention further pertains to a flexible solar cell foil comprising at least one solar cell unit comprising individual solar cells connected in series in such a way that after being mounted in a profiled roofing panel, each cell connected in series will supply essentially the same amount of current. In the present description the term solar cell unit stands for a unit of individual solar cells of which at least two are connected in series. In the present description a flexible solar cell foil comprises a flexible carrier provided with one or more solar cell units.

Solar cells as a rule comprise a photovoltaic layer composed of a photoelectric material provided between a front electrode (at the front of the cell) and a back electrode (at the back of the cell). The front electrode is either transparent or as small as possible, enabling incident light to reach the photoelectric material, where the incident radiation is converted into electric energy. In this way light can be used to generate electric current, offering an interesting alternative to, say fossil fuels or nuclear energy.

At present solar cells are often used in the form of flat sheets. However, especially when they are to be used on houses, it may be desired from an aesthetic point of view to use the solar cells in the form of a profile, more particularly, in the form of a recurrent profile. In this way the exterior of the solar cells can be integrated into the exterior of the rest of the roof covered with, e.g., tiles or corrugated sheets. To achieve this objective, WO 99/66563 describes a roofing panel having the shape of a number of rows and/or columns of tiles, with the roofing panel being provided with at least one solar cell.

U.S. Pat. No. 4,670,293 describes a method of making a semiconductor film on a substrate having a non-flat surface, e.g., a roofing tile. The semiconductor film may be divided into individual solar cells, connected in series to adjacent cells in a conventional manner.

DE Offenlegungsschrift 3626450 describes a glass roofing tile provided with a flexible solar cell sheet.

Y. Ichikawa et al. (Flexible a-Si based solar cells with plastic film substrate, Mat. Res. Soc. Symp. Proc. Vol. 577, pp. 703-712 (1999)) describes the use of flexible solar cell foils in roof covering elements. The solar cells are connected in series to adjacent cells.

EP-A 884432 describes curved roof covering elements provided with a solar cell sheet. The solar cells may be connected in series in a conventional manner.

A problem associated with the application of solar cells on profiled roof covering elements resides in the fact that at a certain position of the sun the solar cell's angle of irradiation varies over its surface area with its position on the profile, an effect which is called shadowing. Thus, not all parts of the solar cell receive the same amount of incident light, and, in consequence, the current generated by the various parts of the solar cell vary with the position on the profile. This detrimentally affects the current generating properties of the solar cell unit as a whole.

Conventionally, to increase the voltage of the module, solar cell foils are divided into a number of individual cells, which are connected in series by connecting the front electrode of one cell with the back electrode of the adjoining cell. Also in this case, shadowing causes problems for the performance of the solar cell unit, because, due to the profile of the unit, at a certain position of the sun not every cell receives the same amount of incident light. The cell which has the least irradiation determines how much current is generated. Moreover, the cell which has the least irradiation may start to act as a resistor connected in series, causing the solar cell unit's output to be additionally reduced.

There is therefore need for a profiled photovoltaic roofing panel comprising a solar cell unit in which these problems have been solved.

According to the invention, this is achieved by providing a photovoltaic roofing panel comprising a carrier and a solar cell unit, the solar cell unit being divided into individual solar cells with at least two solar cells being connected in series, wherein at least one solar cell is connected in series to a non-adjacent solar cell. Preferably, each solar cell connected in series will supply essentially the same amount of current. More preferably, the present invention is directed to a photovoltaic roofing panel comprising a carrier and a solar cell unit, with the carrier having a recurrent profile with a recurrent pattern length l and a profile length k, with the profile length k being the length of the profile in the recurrent pattern length l, with the carrier being provided with a solar cell unit which perpendicular to the recurrent pattern length is divided up into solar cells c₁ . . . cₙ having a width w₁ . . . wₙ, with the sum of w₁ . . . wₙ being equal to the profile length k, and with at least one cell c₁ . . . cₙ being connected in series with the corresponding cell c₁ . . . cₙ of another recurrent profile, with n being an integer with a value of 2 or more.

Since each cell c₁ . . . cₙ of a recurrent profile catches the same amount of incident light as the corresponding cells c₁ . . . cₙ of other recurrent profiles within the solar cell unit, the manner of series connection used in the present invention ensures that cells which generate essentially the same amount of current are connected in series. Therewith, the problems underlying the present invention have been solved. In contrast to the roofing panels of the prior art, in the solar unit of the roofing panel according to the invention, at least one solar cell is connected in series to a non-adjacent solar cell.

By dividing up the solar cell unit into individual solar cells in the direction perpendicular to the recurrent pattern length an essentially homogeneous instantaneous irradiation over the surface of the cell is effected for each individual cell, which improves the current generating properties of the cell. By essentially homogeneous irradiation over the surface of the cell for each individual cell is meant in this case that the maximum deviation in irradiation, expressed in W/m², across the surface area of the cell is at most 20% of the average irradiation across the entire surface area of the cell, preferably at most 10%, more preferably at most 5%, more preferably still at most 1%, most preferably at most 0.5%.

Connecting at least one cell c₁ . . . cₙ in series with the corresponding cell c₁ . . . cₙ of another recurrent profile effects that cells which receive essentially the same quantity of light, and hence will generate essentially the same amount of current, are connected in series. By the stipulation that the cells will generate essentially the same amount of current is meant in this case that the maximum deviation in amount of current generated per cell, expressed in Ampere, of the cells connected in series is at most 25% of the average current generated by the cells connected in series, preferably at most 10%, more preferably at most 5%, more preferably still at most 2%, most preferably at most 1%.

Although the panel of the present invention is indicated as a roofing panel, it will be evident that it can be used not only on roofs but also on walls and in any other applications where the use of profiled panels provided with a solar cell unit may be attractive.

The invention will be further illustrated with reference to the figures.

FIG. 1 shows a perspective drawing of a section of a roofing panel according to the invention in which the recurrent pattern length l, the profiled length k, the cells c₁ . . . cₙ, and the width of the cells w₁ . . . wₙ are shown. The roofing panel has a sinusoidal profile. At least one of the cells c₁ . . . cₙ of the first profile length is connected in series with the cells c₁ . . . cₙ of the adjoining profile length by means of wiring (not shown).

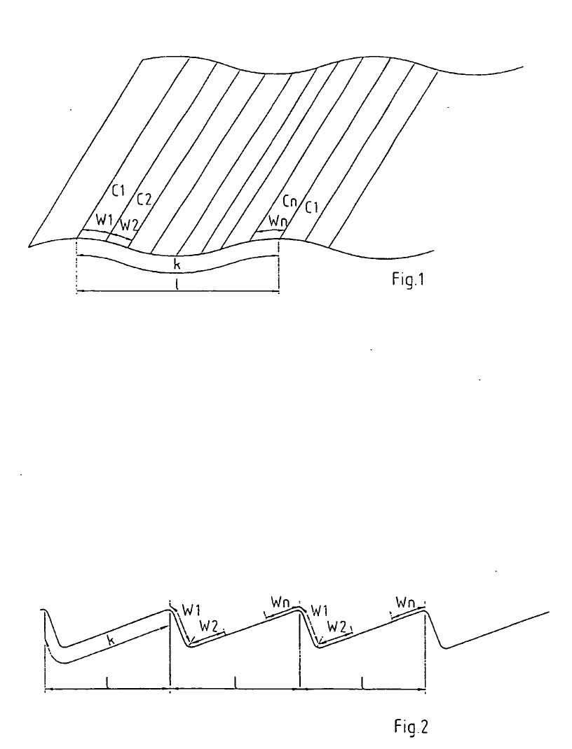

FIG. 2 shows a cross-section of a section of a different roofing panel according to the invention, one with a saw-tooth type profile. Shown are the recurrent pattern length l, the profile length k, and the cell widths w₁ . . . wₙ of the cells c₁ . . . cₙ. At least one of the cells c₁ . . . cₙ of the first profile length is connected in series with the cells c₁ . . . cₙ of the adjoining profile length.

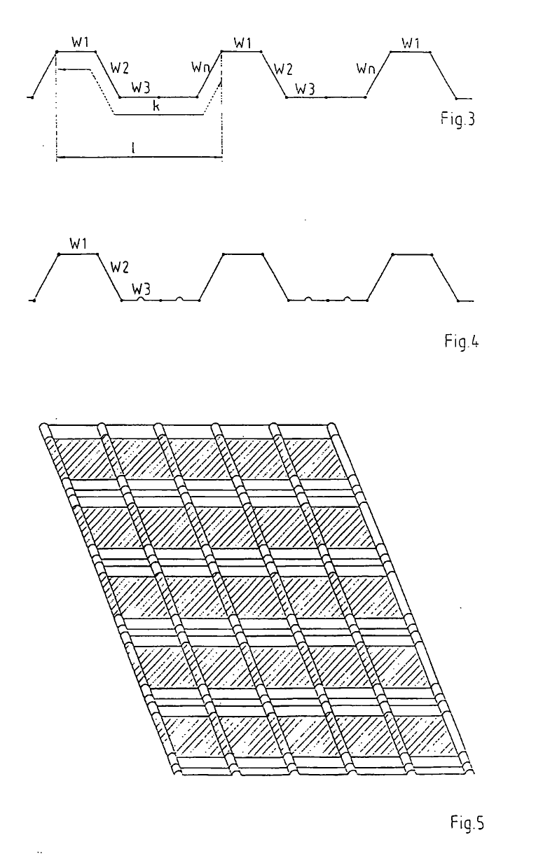

FIG. 3 shows a cross-section of a section of yet another roofing panel according to the invention having a different profile again. Shown are the recurrent pattern length l, the profile length k, and the cell widths w₁ . . . wₙ of the cells c₁ . . . cₙ. At least one of the cells c₁ . . . cₙ of the first profile length is connected in series with the cells c₁ . . . cₙ of the adjoining profile length.

FIG. 4 shows a variation on the roofing panel of FIG. 3 with ridges in the flat section. The division into cells is the same as in FIG. 3.

FIG. 5 shows a roofing panel taking the form of a number of rows and columns of tiles, with the rows of tiles being provided with a solar cell foil.

It is pointed out that these figures are schematic by nature. They do not provide any information on, say, the number of cells per recurrent pattern length or on either the length or the width of the cells.

As has been indicated above, the aim is that in the roofing panel according to the invention the irradiation over the surface area of each cell will be essentially homogeneous. This does not mean that irregularities in the cell surface area are wholly inadmissible. Thus the presence of a ridge in the cells c₃ of the embodiment of FIG. 4 will, depending on the incidence of light, bring about a certain shadow effect in the cells c₃, as a result of which not all of the surface area of the cells c₃ will collect the same quantity of light. However, the ridge is low enough for the consequences of its presence to be acceptable.

As was stated earlier, the roofing panel according to the invention comprises a carrier and at least one solar cell unit. The solar cell unit can be produced directly on the carrier, e.g., by means of direct precipitation of the different layers of the solar cell unit, such as the back electrode, the photovoltaic layer, and the front electrode, on a glass carrier. However, a more attractive option is for the solar cell unit to be manufactured separately in the form of a flexible solar cell foil, which is then applied onto a carrier. The advantage of this is that the manufacture of the solar cell foil, including the establishment of the connection in series, can be carried out with the solar cell foil in a flat position while the flexibility of the solar cell foil enables its use on a profile. The invention for that reason also pertains to a flexible solar cell foil provided with at least one solar cell unit divided up into sets of individual solar cells c₁ . . . cₙ having a width w₁ . . . wₙ, with at least one cell c₁ . . . cₙ being connected in series with the corresponding cell c₁ . . . cₙ, with n being an integer with a value of 2 or more. This connection in series can be established, e.g., as a result of the solar cell unit being provided with an insulation spacer, with the wiring which brings about the connection in series being passed through the spacer. A preferred option of this embodiment is explained in more detail below. Obviously it is also possible to effect the series connection through the carrier, that is, with the wiring which brings about the connection in series being passed through the carrier.

The number of solar cells c₁ . . . cₙ inside a recurrent pattern length l will depend, int. al., on the length of recurrent pattern length l, on the variation in the profile of recurrent pattern length l, and on the desired size of the cells c₁ . . . cₙ. As a rule it holds that the larger the recurrent pattern length l and/or the more intricate the profile, the greater the number of cells desired per recurrent pattern length l. The fact that a more intricate profile leads to more solar cells per recurrent pattern length is to ensure that the homogeneity of the incident light across the individual solar cell remains within acceptable limits. The size of the solar cells will depend on the width w₁ . . . wₙ, but of course also on their length. The appropriate length of the solar cells will depend on the profile of the roofing panel, since if is preferred for the solar cell unit to be profiled in one direction only, viz. in the direction of the recurrent pattern length l. Profiling the solar cell unit in two directions is less preferred due to the requirements this places on the solar cell. The appropriate length will also depend on the selected cell width and the desired cell surface area. As was stated earlier, the sum of the widths w₁ . . . wₙ of the cells c₁ . . . cₙ should be equal to the profile length k. It should be noted in this connection that the width of the connection in series itself is included in the cell width w₁ . . . wₙ.

Depending on the roofing panel profile, the cell widths w₁ . . . wₙ can be the same or not. As was stated earlier, it is important that the homogeneity of the incidence of light across the individual cell remain within acceptable limits. For that reason it may be advisable sometimes to use more narrow solar cells on sharply curved sections of the roofing panel, while less curved sections permit the use of wider cells. However, if the profile is suitable, it is preferred for processing reasons to select constant cell widths w₁ . . . wₙ.

The recurrent pattern length l of the roofing panel will generally be between 5 and 100 cm, preferably between 10 and 60 cm, more preferably between 15 and 45 cm.

The number of cells n per recurrent pattern length will generally be between 2 and 100, preferably between 5 and 50.

In the case of roofing panels having a profile such that on certain sections of the profile adjoining cells have the same irradiation, the adjoining cells with the same irradiation can be connected in series, and this set of cells connected in series in its turn can be connected in series with a corresponding set of cells connected in series of a corresponding section of the profile. In the terminology of this description the adjoining cells with the same irradiation can be indicated as subcells s₁ . . . sₘ. The set of cells s₁ . . . sₘ connected in series in that case corresponds to a cell c having a width w from the set c₁ . . . cₙ having a width w₁ . . . wₙ.

The roofing panel of the present invention comprises a carrier and a solar cell unit provided with solar cells connected in series in a specific manner. The carrier may be made up of one or more sub-panels, and the roofing panel can comprise one or more solar cell units.

The roofing panel according to the invention can be composed of separate units with a width of one recurrent pattern length l which are provided with solar cells, with the connection in series between at least one of the cells c₁ . . . cₙ on one unit and the corresponding cells c₁ . . . cₙ on the other unit being established when the units are laid on a roof. Whether or not this embodiment is attractive will depend for a large part on the size of the unit. If the unit is of the size of a conventional roofing tile, the labour costs associated with the connection of each unit may be prohibitive. On the other hand, for larger units, e.g. units with a width of at least 15 cm and a length of at least one meter, preferably with a length matching the roof length from ridge to gutter, this may be a preferred embodiment of the present invention.

Another embodiment of the present invention is a roofing panel having a width of at least twice the recurrent pattern length l, more preferably, a roofing panel having a width of four to twenty times the recurrent pattern length l. The roofing panel preferably has a width of 30-250 cm, preferably 30-150 cm. Across its width the roofing panel can be covered with several solar cell units, but if the solar cell units are present on a solar cell foil, it is preferred when the roofing panel is covered across its width with a solar cell foil comprising across the width of the panel one solar cell unit with solar cells connected in series. The foil may be provided with several units across the height of the roofing panel.

By the width of the roofing panel is meant within the context of the present description, the width of the roofing panel in the direction of the profile. The height of the roofing panel is the direction perpendicular to the width.

The height of the roofing panel according to the invention is not critical and as a rule will depend on conventional construction sizes. The number of solar cell units provided lengthwise on the roofing panel can vary depending on the situation. When the roofing panel has the shape of, say, a strip of tiles, one solar cell unit heightwise will probably be deemed sufficient. When the roofing panel is higher, say, in the case of corrugated sheet or aluminium roofing profiles, it may be desired to provide more solar cell units along the height of the panel. This may be desired because the height of the solar cell units requires it. Alternatively, it may be desired when the roofing panel has a profile in that direction also, e.g., because the roofing panel has the shape of the number of rows of tiles one above the other. Especially in the case of higher roofing panels it may be attractive to make use of a flexible solar cell foil provided with a number of solar cell units.

A preferred embodiment of the roofing panel according to the invention is a roofing panel having the shape of one or more rows or columns of tiles with at least one row or column of tiles being provided with a solar cell unit connected in series according to the invention is. This embodiment is illustrated in FIG. 5. This figure shows a roofing panel where the exterior takes the form of five rows of five tiles each, with a solar cell unit of five tiles in length being provided on each row (cross-hatched). The division into cells and the connection in series are not shown. The advantage of this embodiment is that in terms of exterior it fits in well with the exterior of conventional tile-covered roofs, while its size makes for easy mounting. Providing the individual rows or columns with a solar cell unit prevents the solar cell unit from displaying a profile in two dierctions. For roofing panels of this type generally for ease of handling preference is given to panels of 1-10 “tiles” wide and 1-8 “tiles” high, with the total number of tiles preferably being at least 4, more preferably at least 8, still more preferably at least 12. The preferred maximum for the number of “tiles” depends on the size of the “tiles” and the desired size of the final unit.

The crux of the series connection in the roofing panel according to the invention is the selection of the cells which are to be connected in series. The series connection as such merely comprises connecting the back electrode of one cell with the front electrode of the other cell. It is within the skilled person's competence to design and mount the required wiring.

As was stated earlier, the invention also pertains to a flexible solar cell foil provided with at least one solar cell unit divided up into individual solar cells, with the solar cells being connected in series in such a way that after being mounted in a profiled roofing panel, each cell in a connection in series will supply essentially the same amount of current. One attractive way of establishing a connection in series is by way of an interconnection layer. Interconnection layers, the principle of which is known from the semiconductor industry, consist of a pattern of mutually insulated conductive stripes. At least one cell from the set of cells c₁ . . . cₙ is connected via a conductive stripe in the interconnection layer with the back electrode of the corresponding cell c₁ . . . cₙ from the adjoining set of cells. The corresponding cells c₁ are connected via a first stripe of the interconnection layer, the corresponding cells c₂ are connected via a second stripe, etc. In order to prevent the TCO of a cell being connected with the back electrode of the same cell, the conductive stripes in the interconnection layer are interrupted by electrically insulating material. This interruption may be effected by cutting the strips or by separate provision of an insulating material.

The invention thus also pertains to a solar cell foil provided with a solar cell unit divided up into sets of individual solar cells c₁ . . . cₙ comprising, from the sunlight incident side downwards, a front electrode, a photovoltaic layer, a back electrode, and an interconnection layer comprising mutually insulated conductive stripes p₁ . . . pₙ provided with electrically insulating material, with at least one cell c₁ . . . cₙ being connected in series via one of the conductive stripes p₁ . . . pₙ with the corresponding cell c₁ . . . cₙ, with n being an integer with a value of 2 or more.

A simple embodiment of this solar cell foil is a foil where the stripes of the interconnection layer are at an angle to the solar cell foil division. The angle preferably is between 60 and 120°, more preferably between 80 and 100°, more preferably still between 88 and 92°. Most preferably, the stripes of the inter-connection layer are essentially perpendicular to the solar cell unit division. In this embodiment the connection in series can be established extremely simply by “pricking” conductive connections between the TCO layer of one cell c₁ . . . cₙ and the interconnection layer and the back electrode of the corresponding cell c₁ . . . cₙ from the adjoining set of cells and the interconnection layer.

Another way of effecting the series connection is by way of coated conductive strips or wire which are connected to the front electrode of one cell and passed along the side of the solar cell unit to the cell to which it is to be connected.

The carrier material of the roofing panel according to the invention is not critical. When the carrier is transparent, e.g., of glass or synthetic material, the solar cell unit optionally may be provided on the bottom of the carrier, ensuring proper protection against outside influences for the solar cell unit. When the solar cell unit is provided on top of the carrier, the carrier does not need to be transparent. Suitable materials in that case include the conventional roofing materials, int. al., ceramic materials, such as concrete, stone, etc., and synthetic materials, optionally on the basis of recycled synthetic material, and metals such as steel, zinc, and aluminium.

The solar cell unit used in the roofing panel according to the invention comprises, back to front, a back electrode, a photovoltaic layer, and a front electrode. Frequently, a carrier is also present to lend the solar cell unit inherent strength. The nature of these materials is not critical to the roofing panel according to the invention. The following description serves only for purposes of illustration.

The carrier of the solar cell unit, if present, can be any known carrier. When the carrier is present on the side of the front electrode, it should be transparent. The carrier may be made of, e.g., glass, or of a transparent polymer. When the carrier is arranged on the side of the back electrode, it may be transparent or not, depending on the envisaged use of the solar cell unit. Suitable materials include flexible materials suitable for use in roll-to-roll processes, such as polymer foils or metal foils.

The front electrode generally is a transparent conductive oxide (TCO). Suitable TCOs include indium tin oxide, zinc oxide, zinc oxide doped with aluminium, fluorine or boron, cadmium sulphide, cadmium oxide, tin oxide, and F-doped SnO₂.

The photovoltaic layer may comprise any suitable system known to the skilled person, e.g., amorphous silicon (a-Si:H), microcrystalline silicon, polycrystalline silicon, monocrystalline silicon, amorphous silicon carbide (a-SiC) and a-SiC:H, amorphous silicon-germanium (a-SiGe) and a-SiGe:H, a-SiSn:H, a-SiSn:H. Also, use may be made of CIS (copper indium diselenide, CuInSe₂), cadmium telluride, Cu(In,Ga)Se, ZnSe/CIS, ZnO/CIS, and Mo/CIS/CdS/ZnO. The use of thin-film solar cells of, say, amorphous or microcrystalline silicon is preferred. The back electrode, which depending on the use of the solar cell unit may also serve as reflector, may be made up, e.g., of aluminium, silver, or a combination of the two.

If so desired, the solar cell unit may comprise additional known components such as encapsulants to protect the unit against environmental effects.

If, as is preferred, a flexible solar cell foil provided with a solar cell unit is used in the roofing panel according to the invention, this preferably is a flexible solar cell foil manufactured by means of a continuous process, preferably a roll-to-roll process. Flexible solar cell foils manufactured as described in WO 98/13882 or WO 99/49483 are especially preferred. These publications are hereby incorporated by reference into the present description as regards the process for manufacturing the flexible solar cell foils and the materials used therein, with the proviso that the series connection methods disclosed in said publications are not suitable to be used in the solar cell unit for use in the roofing panel according to the invention.

1. Photovoltaic roofing panel comprising a carrier and a solar cell unit, the solar cell unit divided into individual solar cells with at least two solar cells being connected in series, wherein at least one solar cell is connected in series to a non-adjacent solar cell.

2. Photovoltaic roofing panel according to claim 1, wherein each cell in a connection in series will supply essentially the same amount of current.

3. Photovoltaic roofing panel according to claim 1 comprising a carrier and a solar cell unit, with the carrier having a recurrent profile with a recurrent pattern length l and a profile length k, with the profile length k being the length of the profile in the recurrent pattern length l, with the carrier being provided with a solar cell unit which perpendicular to the recurrent pattern length l is divided up into solar cells c₁ . . . cₙ having a width w₁ . . . wₙ, with the sum of w₁ . . . wₙ being equal to the profile length k, and with at least one cell c₁ . . . cₙ being connected in series with the corresponding cell c₁ . . . cₙ of another recurrent profile, with n being an integer with a value of 2 or more.

4. A roofing panel according to claim 1 wherein the solar cell unit comprises a flexible solar cell foil.

5. A roofing panel according to claim 3 wherein the cell width w₁ . . . wₙ is constant.

6. A roofing panel according to claim 3 made up of separate units with a width of one recurrent pattern length l.

7. A roofing panel according to claim 3 which has a width of at least twice the recurrent pattern length l, more preferably a width of four to twenty times the recurrent pattern length l.

8. A roofing panel according to claim 7 which across its width is covered with one solar cell unit comprising a solar cell foil with solar cells connected in series.

9. A roofing panel according to claim 1 which has the shape of one or more rows or columns of tiles, with at least one row or column of tiles being provided with a solar cell unit.

10. A roofing panel according to claim 3 wherein within one solar cell unit all the cells c₁ . . . cₙ are connected in series with all the corresponding cells c₁ . . . cₙ within said solar cell unit.

11. A roofing panel according to claim 3 wherein at least one cell c from the set c₁ . . . cₙ is composed of a set of adjoining subcells s₁ . . . sₘ connected in series.

12. Flexible solar cell foil comprising a solar cell unit divided into individual solar cells with at least two solar cells being connected in series, wherein at least one solar cell is connected in series to a non-adjacent solar cell.

13. Flexible solar cell foil comprising a solar cell unit divided up into individual solar cells, with the solar cells being connected in series in such a way that after being mounted in a roofing panel according to any one of the preceding claims, each cell in a connection in series will supply essentially the same amount of current.

14. Flexible solar cell foil comprising a solar cell unit divided up into sets of individual solar cells c₁ . . . cₙ having a width w₁ . . . wₙ, with at least one cell c₁ . . . cₙ being connected in series with the corresponding cell c₁ . . . cₙ, with n being an integer with a value of 2 or more.

15. A solar cell foil according to claim 12 which is provided with an insulation spacer, with the wiring which establishes the series connection being passed through the spacer.

16. Flexible solar cell foil comprising a solar cell unit divided up into sets of individual solar cells c₁ . . . cₙ comprising, from the sunlight incident side downwards, a front electrode, a photovoltaic layer, a back electrode, and an interconnection layer comprising mutually insulated conductive stripes p₁ . . . pₙ provided with electrically insulating material, with at least one cell c₁ . . . cₙ being connected in series via one of the conductive stripes p₁ . . . pₙ with the corresponding cell c₁ . . . cₙ, with n being an integer with a value of 2 or more.

17. A solar cell foil according to claim 16 wherein the stripes of the interconnection layer are essentially perpendicular to the solar cell foil division and wherein the series connection is established by “pricking” conductive connections between the TCO layer of one cell c₁ . . . cₙ and the interconnection layer and the back electrode of the corresponding cell c₁ . . . cₙ from the adjoining set of cells and the interconnection layer.
